(19) United States
(12) Patent Application Publication
(10) Pub. No.: US 2013/0327765 A1
(43) Pub. Date: Dec. 12, 2013

(54) MULTI-SECTION RECYCLING BIN

(71) Applicants: Matthew Hirota, Merced, CA (US); Eric D. Scott, Merced, CA (US)

(72) Inventors: Matthew Hirota, Merced, CA (US); Eric D. Scott, Merced, CA (US)

(73) Assignee: The Regents of the University of California

(21) Appl. No.: 13/494,860

(22) Filed: Jun. 12, 2012

(51) Int. Cl. B65F 1/08; B65D 25/04

(52) U.S. Cl. 220/23.88; 220/500; 220/524

(57) ABSTRACT

Described herein is a multi-section housing unit for a trash bin comprising: one or three sides, a top surface and a bottom surface such that an inner space is defined within the housing unit, and wherein said inner space is separated into three compartments; said top surface having three openings, each of said openings positioned over each compartment; three cabinet doors, wherein each cabinet door defines a portion of the one to three sides of the bin and opens into one of the three said compartments; and an opening means on each cabinet door. The multi-section housing unit is useful for the collection of waste and the separation of trash, recyclable, and compostable waste.

### BACKGROUND

The collection of materials such as paper, glass and metal for recycling and/or compost is becoming more common in our society. Thus, many communities have separate containers for the division of landfill/trash, recyclable, and compostable waste. With the increased concern and awareness for the environment throughout the world, recycling has become an accepted part of modern society.

Ideally, containers for the collection of waste should allow for the separation of trash, recyclable, and compostable waste; be aesthetically satisfactory when placed in a central location; and be ergonomically acceptable to allow for easy collection of the deposited materials. Most existing products are boxy and meant to reside in a peripheral location or are ergonomically unacceptable, requiring the vertical lifting of heavy bags from the containers. Therefore, there is a need in the art for products that fit the needs of communities that have adopted recycling and composting practices.

### SUMMARY

It is an object of the present invention to provide a bin which can be aesthetically suitable in a central location and ergonomically suitable to those that maintain the bin. Aspects of the disclosure relate to a multi-section housing unit for a trash bin comprising: at least one, at least three, or at least four sides located adjacent to and joining a top and a bottom surface and an inner space is defined within the top and bottom surface, and wherein said inner space is separated into three compartments; said top surface having an opening for each compartment; each of said openings positioned over each compartment; an access for each compartment, wherein access (e.g. door) defines a portion of the at least one, three, or four sides of the bin and opens into one of the three said compartments; and each compartment provides egress to and from the compartments; and an opening means on each access.

In one embodiment, the housing unit further comprising three or more means to move the housing unit (e.g. rollers) wherein the means to move the housing unit or rollers are positioned on the bottom surface. In another embodiment, the housing unit comprises three rollers. The term roller is intended to mean a device which allows the housing unit to roll freely on the floor, such as wheels. The wheels or roller may be rotatably mounted to the bottom surface of the housing unit in positions that stabilize the unit and also allow for the rolling of the unit across a surface when such is desired. The roller or wheels may be equipped with a locking device that locks the wheels in place and restricts the movement of the housing unit.

In further embodiments, the multi-section housing unit comprises one side. In a related embodiment, the housing unit is cylindrical. The housing unit may also comprise three sides and be triangular. The round and triangular-shaped housing units allow the bin to be placed in a central location and allow for the openings to be accessible from all directions of said location.

In one embodiment, the housing unit further comprises three or more removable trash bins wherein each trash bin is located in the inner space of each of the three or more said compartments. The trash bins are positioned in each compartment so that the opening of each of the trash bins corresponds to the opening of the housing unit. Traditional trash bin liners may be employed so that the bins can be easily emptied and maintained. The trash bins may be cylindrical, rectangular, or triangular, but the opening should be larger in width or diameter than the opening of the housing unit. This property allows for the unobstructed deposit of waste materials into the housing unit. In one embodiment, the removable trash bins are cylindrical in shape and open at the top.

In one embodiment, the housing unit is separated into three compartments. The three compartments may be used for the collection and separation of landfill waste, compostables, and recyclables. The three compartments may be color-coded and labeled so that the intended content of the compartment is easily identifiable. For example, one compartment may be color-coded blue and labeled “recycle” for recyclables. Another compartment may be color-coded green and labeled “compost” for compostables. The third compartment may be color-coded grey or white and labeled “landfill” for waste.

When the removable bin is cylindrical or square, the diameter or width of the bin is larger than the opening in the housing unit. In certain embodiments, the diameter or width of the top opening of the removable trash bins are from about 8 inches to about 19 inches or, alternatively, from about 8.5 inches to about 18.5 inches, or from about 10 inches to about 17 inches or from about 12 inches to about 16 inches or from about 14 to about 16 inches. In one embodiment, the diameter or width is about 15.25 inches. In further embodiments, the diameter or width can be about 8, about 9, about 10, about 11, about 12, about 13, about 14, about 15, about 16, about 17, about 18, or about 19 inches. In further embodiments, the top opening of the removable trash bin is from about 0.25 inches to about 5 inches more in diameter or width than the openings on the top surface of the housing unit. Alternatively, the top opening of the trash bin can be about 1 inch to about 5 inches, or about 2 inches to about 4 inches, or about 3 inches to about 4 inches more in diameter or width than the openings on the top surface of the housing unit.

The openings of the housing unit may be any shape such as square, circular, triangular, or rectangular. In one embodiment, the openings are circular. The diameter of the openings should be such that, when a removable bin is placed inside, the opening of the housing unit is smaller than the opening of the removable bin. In a specific embodiment, the three openings in the housing unit are circular.

When the openings in the housing unit are circular or square, the diameter or width of the openings can be from about 7 to about 18 inches. In other embodiments, the diameter or width of the openings of the housing unit is from about 8 to about 16 inches, or from about 9 to about 15 inches or from about 10 to about 14 inches or from about 11 to about 13 inches. In one embodiment, the diameter or width of the opening of the housing unit is about 12 inches. In further embodiments, the diameter or width of the opening of the housing unit is about 7, 8, 9, 10, 11, 12, 13, 14, 15, 16, 17, 18, or 19 inches.

When the housing unit is cylindrical, the diameter of the housing unit can be from about 30 to about 50 inches. In some embodiments, the diameter is from about 35 to about 45 inches or from about 38 to about 42 inches. In one embodiment, the diameter is about 39.9 inches. In other embodiments, the diameter is about 30, 31, 32, 33, 34, 35, 36, 37, 38, 39, 40, 41, 42, 43, 44, 45, 46, 47, 48, 49, or 50 inches.

The opening means on the cabinet door may be any opening means that allows for the opening of the cabinet for easy access to the inner compartment. The opening means may be, for example, a handle, a knob, a touch latch, a push button latch or a push-open latch. The Touch Latch is a secure, concealed latch used on many styles of cabinets and doors. It is operated by pulling on the cabinet door to release the catch, then latches securely into place when the cabinet is closed. A push-open latch mounts inside the door and provides a secure closure it is operated by simply pushing on the cabinet door to release the catch, then by closing the cabinet to secure it. In a push button latch, the knob is pushed once to disengage the strike, and the door opens. Pushing the knob again engages the strike and locks the door. In one embodiment, the opening means comprises a handle. In another embodiment, the opening means comprises a push button latch. In a further embodiment, the opening means comprises a handle and a push-open latch.

The cabinet doors may be any size suitable for the housing unit. In certain embodiments, the cabinet doors are from about 20 to about 40 inches in length. The length of the cabinet door corresponds to the distance from the top of the door to the bottom of the door. In other embodiments, the cabinet doors are from about 25 to about 30 inches in length or from about 27 to about 32 inches in length. In certain embodiments, the cabinet doors are about 30.75, 20, 22, 24, 26, 28, 30, 32, 34, 36, 38, 40, 42, 44, 46, 48, or 50 inches in length.

The housing unit may be any size suitable for the location in which it is placed. In some embodiments the housing unit is from about 20 to about 50 inches tall or from about 23 to about 44 inches, or from about 30 to about 40 inches or from about 40 to 50 inches tall. In certain embodiments, the housing unit is 20, 22, 24, 26, 28, 30, 32, 34, 36, 38, 38.44, 40, 42, 44, 46, 48, or 50 inches tall.

The housing unit may also be scalable for use in different situations. For example, when the housing unit is for use at public places such as universities or malls, the unit should be scaled so that it is suitable for use by adults. However, the housing unit may also be used in schools with small children. In this instance, it may be beneficial to scale the unit so that it is easily accessible to small children. Accordingly, in one embodiment, the housing unit as described herein is scalable.

### BRIEF DESCRIPTION OF THE FIGURES

FIG. 1 is a top plan view of the multi-section housing unit;

FIG. 2 is a front elevational view of the multi-section housing unit;

FIG. 3 is a view that shows interior and underside details;

FIG. 4 is a back elevational view of the multi-section housing unit;

FIG. 5 is a view of the Push button latch and door of the multi-section housing unit.

FIG. 6-9 depict perspective views of the multi-section housing unit from various angles.

### DESCRIPTION OF EMBODIMENTS

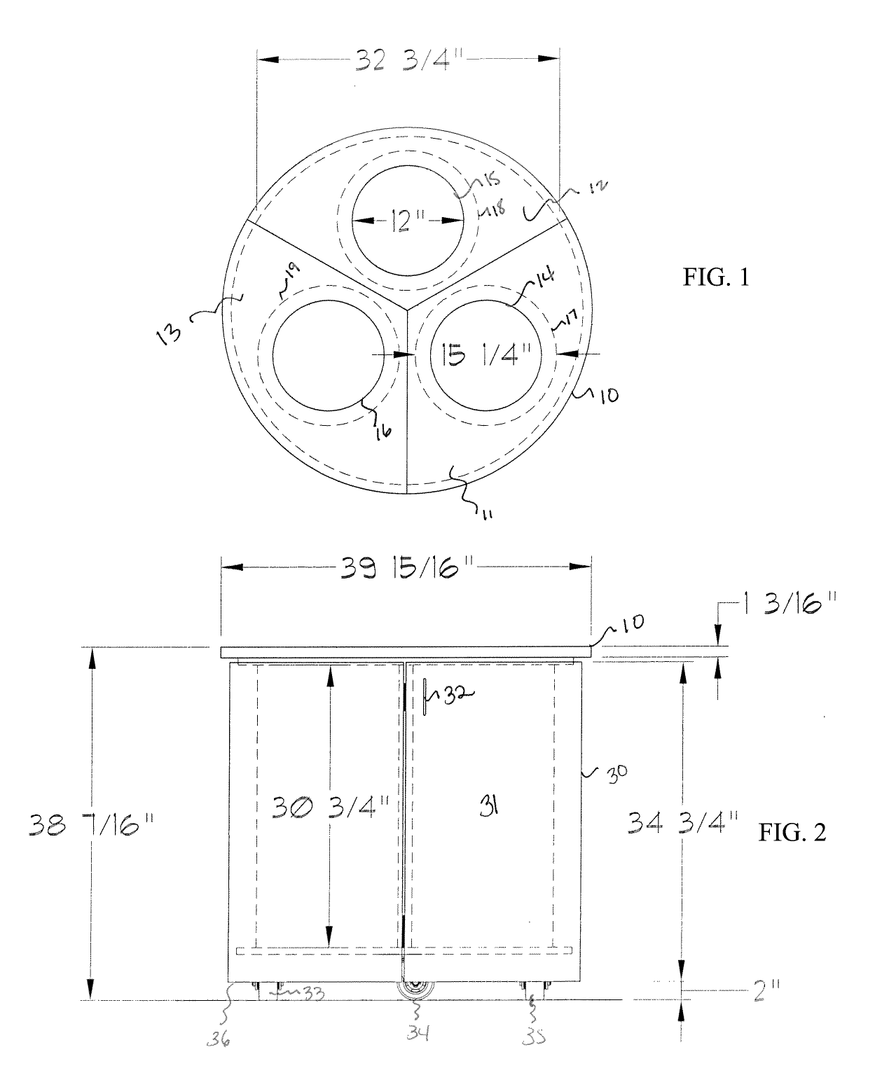

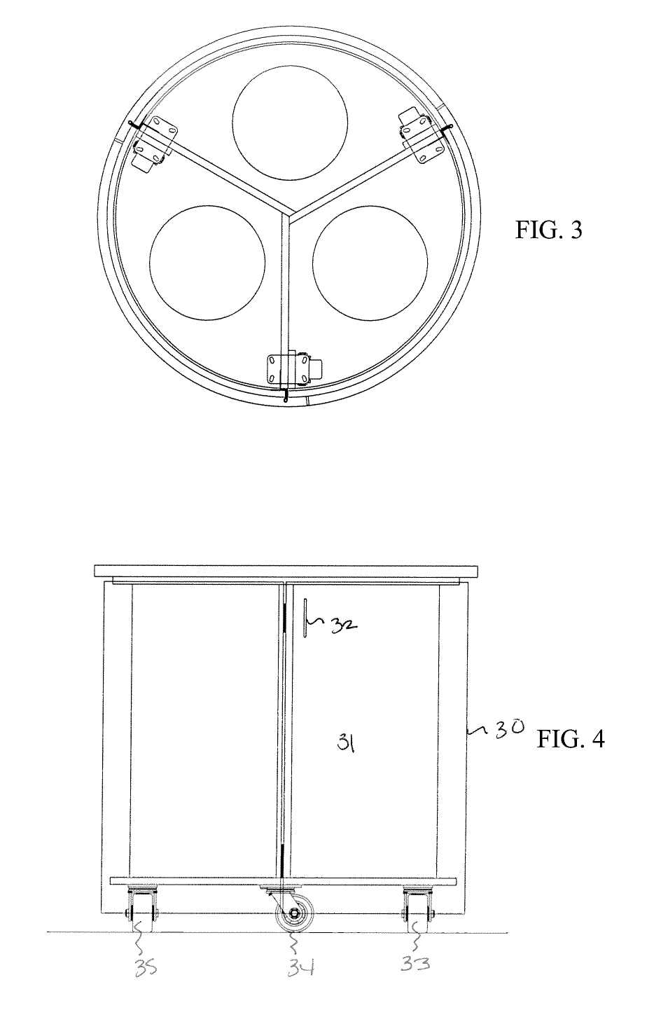

Referring to the drawings, the present disclosure is directed to a multi-section housing unit for the collection of trash, recyclables, and compostables in one housing unit. Referring to FIG. 1, the invention includes a top lid or top surface, generally designated 10. The top lid may be removable or may be attached to the housing unit, generally designated as 30 (FIG. 2). In the embodiment depicted in FIG. 1, the top surface of the housing unit is circular, has a diameter of approximately 39.94 inches and is divided into three equal sections, designated 11-13. Each section of the top surface has an opening, designated 14-16, that opens into the inner space of the housing unit. The openings 14-16 in FIG. 1 are circular and twelve inches in diameter. In the embodiment depicted in FIG. 1, three removable trash bins are depicted as being in the inner space of each compartment. The trash bins are depicted as cylindrical in shape and open at the top. The top opening of the each trash bin is designated as 17-19 and is depicted as a circle outlined by a dashed line. The diameter of the removable trash bins depicted in FIG. 1 is approximately 15.25 inches.

FIG. 3 is a top view of the multi-section housing unit. The diagram shows details of the internal design as well as elements of the base structure such as wheels/casters. The compartments are roughly triangular shaped and designed precisely to accommodate industry standard rigid plastic insert liners so that they align correctly with the deposit holes in the top of the unit. All elements of the unit are fixed with the exception of the doors which allow access to and removal of the rigid plastic insert liners.

FIG. 2 is a front elevational view of the multi-section housing unit. In the embodiment depicted in the figures, the housing unit, generally designated, as 30, is cylindrical in shape and has three cabinet doors on the outer surface of the housing unit. The cabinet door shown in FIG. 2 is designated 31. The cabinet door, 31, is approximately 30.75 inches in height and has an opening means, 32, which is depicted as a handle. The cabinet door may also have a hinge that connects the cabinet door to the housing unit and allows for the opening of the cabinet door into the inner space. The height of the housing unit, 30, is approximately 34.75 inches. In the embodiment depicted by the figures, the housing unit comprises three rollers, designated 33-35, positioned on the bottom surface, 36. The height of the housing unit, including the rollers, 33-35, and top surface, 10, is approximately 38.44 inches. The rollers, 33-35, raise the housing unit, 30, by approximately two inches. FIG. 4 is a back elevational view of our multi-section housing unit, 30. Depicted are cabinet doors, with an opening means and rollers as previously described. The housing unit, 30, and its components, can be constructed with a variety of materials (wood, laminates, metal, plastic) allowing more customized applications. It could also be made in other sizes based on standard commercially available waste can liners such as standard Rubbermaid rigid liners.

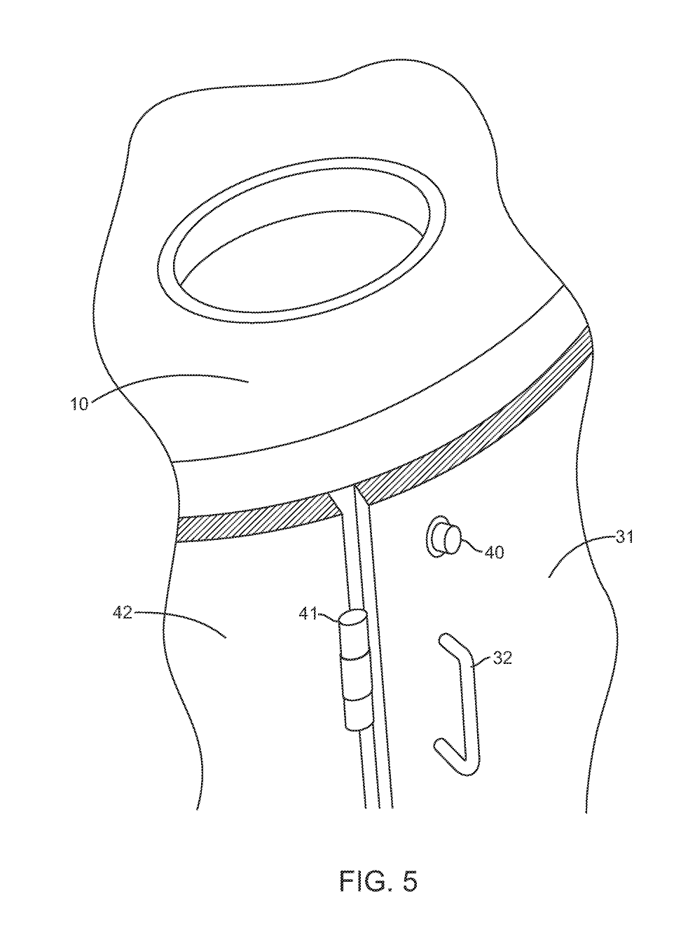

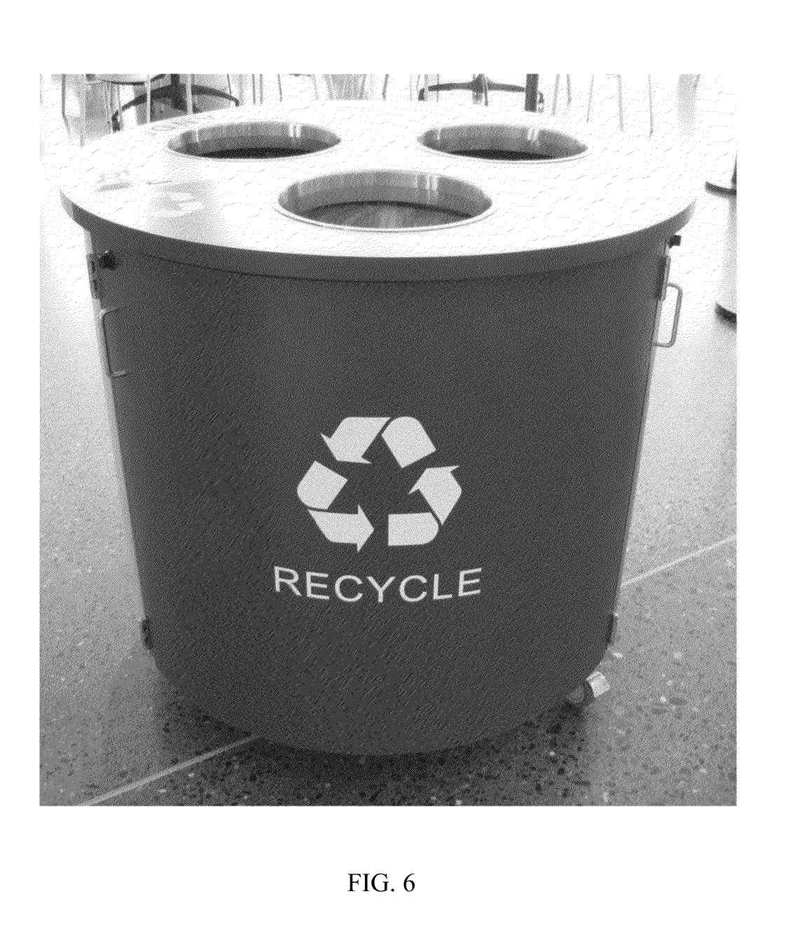

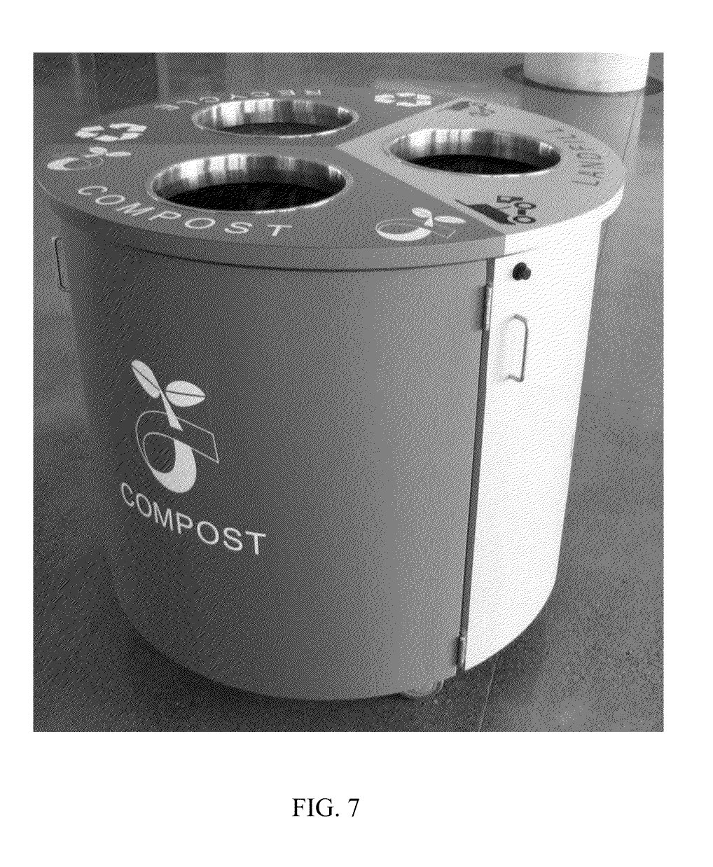

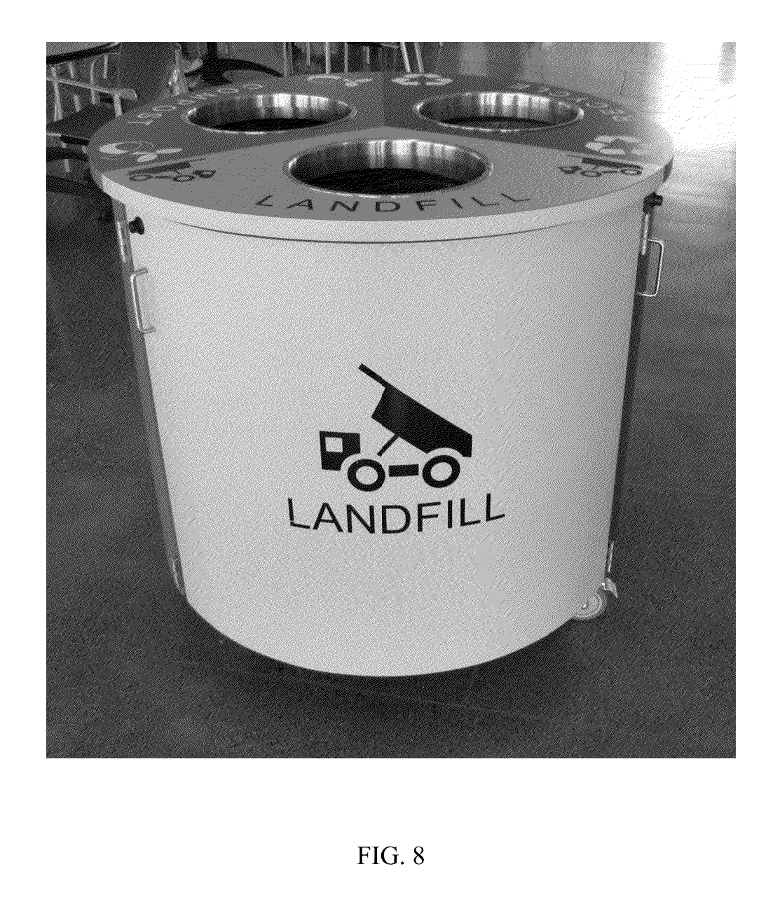

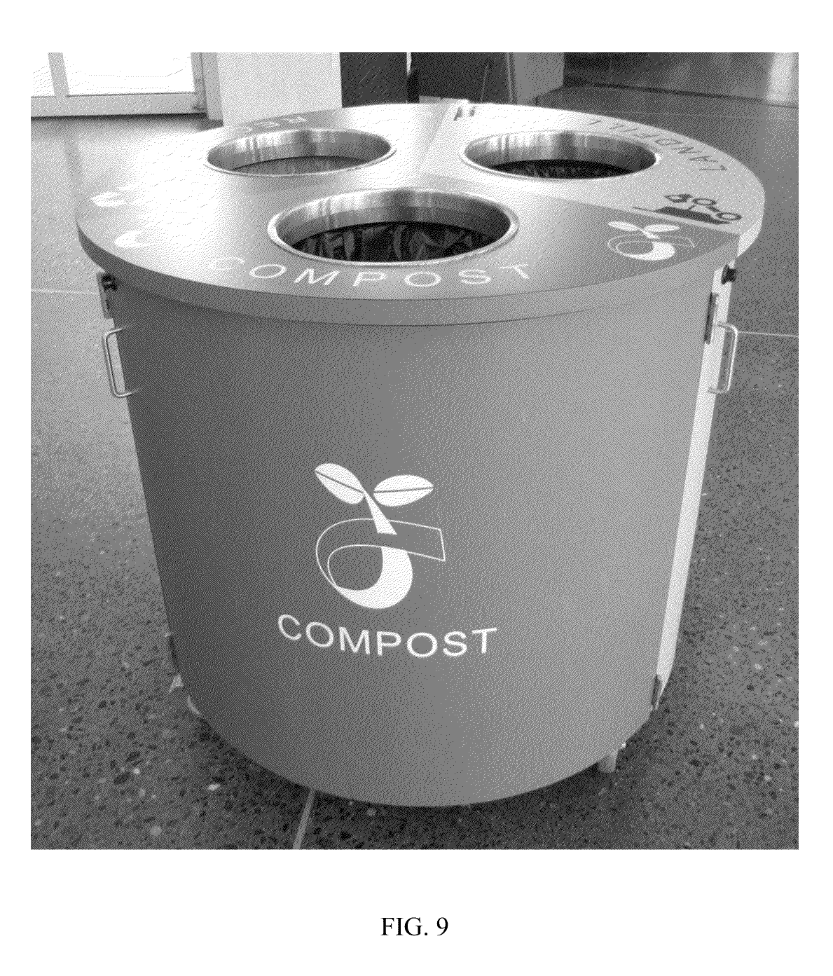

FIG. 5 is a view of the Push button latch, designated 40 and door, 31, of the multi-section housing unit. Also shown is the handle, 32, which is depicted as a four inch wire pull. The hinge, 41, of the neighboring cabinet, 42, is also depicted. Finally, the top surface, 10, is shown with the twelve inch opening (either 14, 15, or 16).

It should be understood that although the present invention has been specifically disclosed by preferred embodiments and optional features, modification, improvement and variation of the inventions embodied therein herein disclosed may be resorted to by those skilled in the art, and that such modifications, improvements and variations are considered to be within the scope of this invention. The materials, methods, and examples provided here are representative of preferred embodiments, are exemplary, and are not intended as limitations on the scope of the invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

All publications, patent applications, patents, and other references mentioned herein are expressly incorporated by reference in their entirety, to the same extent as if each were incorporated by reference individually. In case of conflict, the present specification, including definitions, will control.

1. A multi-section housing unit for a trash bin comprising:
at least one, at least three, or at least four sides located adjacent to and joining a top and a bottom surface and an inner space is defined within the top and bottom surface, and wherein said inner space is separated into three compartments; said top surface having an opening for each compartment; each of said openings positioned over each compartment;
an access for each compartment, wherein each access defines a portion of the at least one, three, or four sides of the bin and opens into one of the three said compartments; and each compartment provides egress to and from the compartments;
an opening means on each access; and
three removable cylindrical trash bins that open at the top and are located in the inner space of each of the three said compartments;
wherein each section of the housing unit defining each of the three inner compartments is color-coded and labeled; and
wherein one section is color-coded blue and labeled “recycle;” wherein one section is color-coded green and labeled “compost;” and wherein one section is color-coded grey and labeled “landfill.”

2. The multi-section housing unit of claim 1 further comprising means to move the housing unit positioned on the bottom surface.

3. The multi-section housing unit of claim 1 wherein the housing unit comprises one side.

4. The multi-section housing unit of claim 3 wherein the housing unit is cylindrical.

5. The multi-section housing unit of claim 1 wherein the housing unit comprises three sides.

6. The multi-section housing unit of claim 5 wherein the housing unit is triangular.

7-8. (canceled)

9. The multi-section housing unit of claim 1 wherein said top opening of the removable trash bin is from about 8.5 inches to about 18.5 inches in diameter.

10. The multi-section housing unit of claim 9 wherein said top opening of the removable trash bins are about 15.25 inches in diameter.

11. The multi-section housing unit of claim 1 wherein said top opening of the removable trash bins are from about 0.25 inches to about 5 inches more in diameter than the openings on the top surface of the housing unit.

12. The multi-section housing unit of claim 1 wherein the three openings are circular.

13. The multi-section housing unit of claim 12 wherein the diameter of the openings are from about 8 inches to about 16 inches.

14. The multi-section housing unit of claim 13 wherein the diameter of the openings are about 12 inches.

15. The multi-section housing unit of claim 2 comprising three rollers.

16. The multi-section housing unit of claim 4 wherein the diameter of the housing unit is from about 35 inches to about 45 inches.

17. The multi-section housing unit of claim 16 wherein the diameter of the housing unit is about 39.94 inches.

18. The multi-section housing unit of claim 1 wherein the opening means comprises a handle.

19. The multi-section housing unit of claim 1 wherein the opening means comprises a push-open latch.

20. The multi-section housing unit of claim 1 wherein the opening means comprises a handle and a push-open latch.

21. The multi-section housing unit of claim 1 wherein the length of the cabinet doors is from about 25 inches to about 35 inches.

22. The multi-section housing unit of claim 21 wherein the length of the cabinet doors is about 30.75 inches.

23. The multi-section housing unit of claim 1 wherein the length of the housing unit is from about 23 inches to about 44 inches.

24. The multi-section housing unit of claim 1 wherein the length of the housing unit is about 38.44 inches.

25. The multi-section housing unit of claim 1 wherein the top surface is round with 3 openings for deposit of waste.

26-28. (canceled)

29. The multi-section housing unit of claim 1 wherein the housing unit is scalable.
